(19) United States
(12) Patent Application Publication
(10) Pub. No.: US 2011/0297181 A1
(43) Pub. Date: Dec. 8, 2011

(54) Dental Hygenic Aids Having Natural Antimicrobial Properties

(76) Inventor: Michael Soloway, Santa Fe, NM (US)

(21) Appl. No.: 13/126,080

(22) PCT Filed: Jun. 2, 2010
(86) PCT No.: PCT/US2010/037126

§ 371 Date: Apr. 26, 2011

(51) Int. Cl. A61C 15/04; D02G 3/02; D04C 1/00; A46B 9/04

(52) U.S. Cl. 132/321; 15/167.1; 57/362; 87/8

(57) ABSTRACT

A dental hygenic aid (910, 920, 930) comprising a bundle of linear elements, wherein each of said elements comprises multiple strands of natural fiber (800), and wherein at least a portion of said natural fiber-based strands have inherent anti-microbial properties.

### TECHNICAL FIELD

The present invention relates to dental hygenic aids. More particularly the devices and methods herein disclosed relate to dental hygenic aids comprised of natural fibers which have inherent antimicrobial properties, and which can be used to form flosses or tooth brush bristles.

### BACKGROUND ART

Tooth decay and dental disease can be caused by bacterial action resulting from the formation of plaque about the teeth and/or the entrapment of food particles in interstices between the teeth. Removal of plaque and entrapped food particles reduces the incidence of caries, gingivitis, and mouth odors as well as generally improving oral hygiene. Conventional brushing of teeth is not particularly effective in removing entrapped food particles from crevices between the teeth and/or removing plaque which enables bacteria to adhere to teeth, so dental flosses and tapes have been recommended as a supplement.

The first mass-produced toothbrushes appeared in England in 1780. The concept of using dental floss for cleansing interproximal spaces appears to have been introduced by Parmly in 1819. Numerous types of floss were developed and used for cleaning interproximal and subgingival surfaces, until finally in 1948 Bass established the optimum characteristics of dental floss.

Over time, various materials have been used to create dental hygenic aids. In the early years, the materials used were the materials at hand, i.e., animal hairs and fibers, silk, cotton. In the early 20th century, plastics, polymers, and other synthetic materials replaced natural materials.

With respect to both dental floss and tooth brush bristle material, certain characteristics are typically considered desirable. First, the material should be abrasion resistant such that it does not shred, fray, or otherwise break during use. Second, the material should not be perfectly smooth, as the surface roughness of the material assists in removing debris, plaque, and the like. Additionally, the strength of the material selected should decay gradually with use to prevent breakage (for use in floss), or permanent deformation (for use in bristles).

Dental flosses come in two different forms: multi-filament “threads”, and tapes or ribbons. As a tape the floss should have a denier of about 1200 to 3000 or more. As thread the individual filaments should have a denier of about 100 to 800. The advantage of thread over a tape is that in use the filaments of a multi-filament thread floss splay and assist in the removal of food particles, debris and plaque from between the teeth and under the gum line. This enhanced cleaning comes from the splayed filaments each rubbing the surface of a tooth. The use of a plurality of filaments appears to exhibit an increased removal of certain particles and plaque. Additionally, dental flosses using man-made materials have been created which have a thickened “brush” portion, at random or constant intervals along the main thread. The brush portion, when drawn between tooth surfaces, provides good cleaning action which removes materials left by a standard thin floss used alone. To form a brush floss, it is necessary to provide bulked filaments in a strand of floss, i.e., filaments which are separated and have a somewhat sinuous, random orientation.

Currently, the US Food and Drug Administration (FDA) has approved three basic nylon fiber bundle constructions for thread dental floss. The three basic constructions are: 140 denier (68 filament), 100 denier (34 filament) and 70 denier (34 filament). Heretofore, 6 to 10 bundles of these three types were twisted together along with bonding agents to produce various commercial dental flosses. With respect to the materials currently used for floss and bristles, these man-made materials have several advantages, including greater control of the material properties (e.g., size, strength, ductility), consistency of manufacture, and the ability to incorporate other man-made chemical compositions, such as colorings, sweeteners, or medical agents. However, these synthetic materials typically require the use of petroleum products for their creation, making their continued use problematic.

Several natural fibers have been used for dental hygiene articles. However, the majority of these fibers were discounted as synthetic fibers became dominant. One type of fiber that has not been historically considered comes from the Agave family. Agave is a succulent plant of a large botanical genus of the same name, belonging to the family Agavaceae. Although having various uses since antiquity, none include use in oral hygiene.

Additionally, traditional healers have long used plants to prevent or cure infectious disease. Many of these plants have been investigated scientifically for antimicrobial activity and a large number of plant products have been shown to inhibit the growth of pathogenic microorganisms. However, none have ever been used as a disease preventive for oral hygiene.

Thus, there is a need in the art for a natural replacement for the materials used for dental flosses, tapes, and toothbrush bristles. The replacement must meet the current material properties of existing flosses, tapes, and toothbrush bristles, and should include natural antimicrobial properties. The material should further include the capability to incorporate additives beneficial for maintaining oral hygiene without disturbing its natural antimicrobial properties.

### BRIEF DESCRIPTION OF THE DRAWINGS

In order that the present invention may be more readily understood, reference will now be made to the accompanying drawings, in which:

FIG. 1 illustrates details of the processing of leaf portions of a plant of the Agave family according to one embodiment; and

FIG. 2 illustrates the process of combining individual fibers into strands and the structures resulting therefrom as utilized in dental floss and a toothbrush according to one embodiment.

### DISCLOSURE OF THE INVENTION

The invention comprises several general aspects, each of which can, if desired, be combined with additional features, including features disclosed and/or not disclosed herein, resulting in combinations representing more detailed optional embodiments of these aspects.

In accordance with this invention, there is provided a dental hygienic aid able to be crafted in to various types of flosses and/or bristles wherein said aid is comprised of natural fibers which have inherent antimicrobial/antibacterial properties.

In a first aspect of this invention, the dental hygienic aid comprises a bundle of linear elements, wherein each of said elements comprises multiple strands of natural fiber, and wherein at least a portion of said natural fiber-based strands have inherent anti-microbial properties.

In some forms of this first aspect, the dental hygienic aid may further incorporate at least one natural dentrifice.

In other forms the dental hygienic aid may form a ribbon floss, a thread floss, and/or the bristles on a toothbrush.

In yet other forms, the natural fiber may be a bast fiber or a leaf fiber.

In related forms, at least some portion of the fibers may come from abacá, agave, flax, henequen, hemp, jute, kenaf, ramie, sisal, and/or yucca plants, or may come from plants within the plant families of Agavaceae, Apocynaceae, Fabaceae, Hemerocallidaceae, Linaceae, Malvaceae, Musaceae, Tiliaceae and Urticaceae.

With respect to various species of the aforementioned families, suitable fibers may come from, but are not limited to: Agave (A.) aboriginum, A. americana, A. angustifolia, A. attenuata, A. asperrima, A. bracteosa, A. cacozela, A. cajalbanensis, A. deserti, A. ferox, A. filifera, A. horrida, A. inaequidens, A. lophanta, A. lechuguilla, A. palmeri, A. parrasana, A. parryipicta, A. potatorum, A. scabra, A. schidigera, A. schottii, A. sebastiana, A. shawiisisalana, A. sisalana, A. striata, A. stricta, A. tequilana, A. utahensis, A. victoriae-reginae, A. vilmoriniana, A. wislizeni, Apocynum androsaemifolium, Apocynum cannabinum, Apocynum hendersonii, Apocynum medium, Apocynum pictum, Apocynum sibiricum, Apocynum venetum, Boehmeria nivea, Boehmeria platanifolia, Boehmeria tenacissima, Corchorus (C.) aestuans, C. capsularis, C. carnarvonensis, C. cunninghamii, C. erodiodes, C. junodi, C. olitorius, C. sidoides, C. tridens, C. walcottii, Crotalaria juncea, Hibiscus (H.) cannabinus, H. elatus, H. rosa-sinensis, H. sabdariffa, Linum (L.) austriacum, L. bienne, L. catharticum, L. cratericola, L. flavum, L. grandiflorum, L. leoni, L. lewisii, L. medium, L. perenne, L. puberulum, L. pubescens, L. suffruticosum, L. tenuifolium, L. dolomiticum, L. usitatissimum, Phormium cookianum, Phormium tenax, Musa sapientum, and/or Musa textilis.

In certain forms, fibers may have a denier of at least 100, and a tensile strength of at least 30 cN/tex.

In a second aspect, the invention comprises a method of manufacturing a dental hygienic aid comprising natural fibers having antimicrobial properties, comprising the steps of extracting a natural fiber into strands, assembling a series of strands to form a plurality of roving, and entangling said strands without the addition of binding agents, and without diminishing the anti-microbial properties present.

In various forms of this second aspect, the strands may be twisted or braided together.

In other forms at least some strands may have different thickness than other strands such that said aid has a non-uniform thickness.

In still other forms, the ends of at least some fibers may protrude from the surface of said thread.

### BEST MODE FOR CARRYING OUT THE INVENTION

Several natural fibers have previously been used as a dentrifice. However, most of these, while have the requisite tensile strength (for example, silk), lacked an appropriate size (diameter, or thickness for ribbon shapes), and more importantly, any inherent antibacterial properties. Those natural fibers having antibacterial properties have likewise, been historically unsuitable for use as a dentrifice since they lacked the necessary size and/or tensile strength. Thus, the current invention resolves this dilemma by the manufacture of natural fibers having inherent antibacterial properties into a size and shape required for a dentrifice, and without neglecting tensile strength.

A suitable example of such a fiber that can, through the present invention, be used as a dentrifice are fibers from various members of the agave family (Agavaceae). While several members have various levels and types of antibacterial and/or antimicrobial properties, none had been discovered which, when prepared through the proper process, could be used as dentrifice. One such example is Agave picta. The Agave picta is member of the agave family can be found in Mexico and other North and Central American locations. The plant can be found growing randomly, or can be cultivated 100.

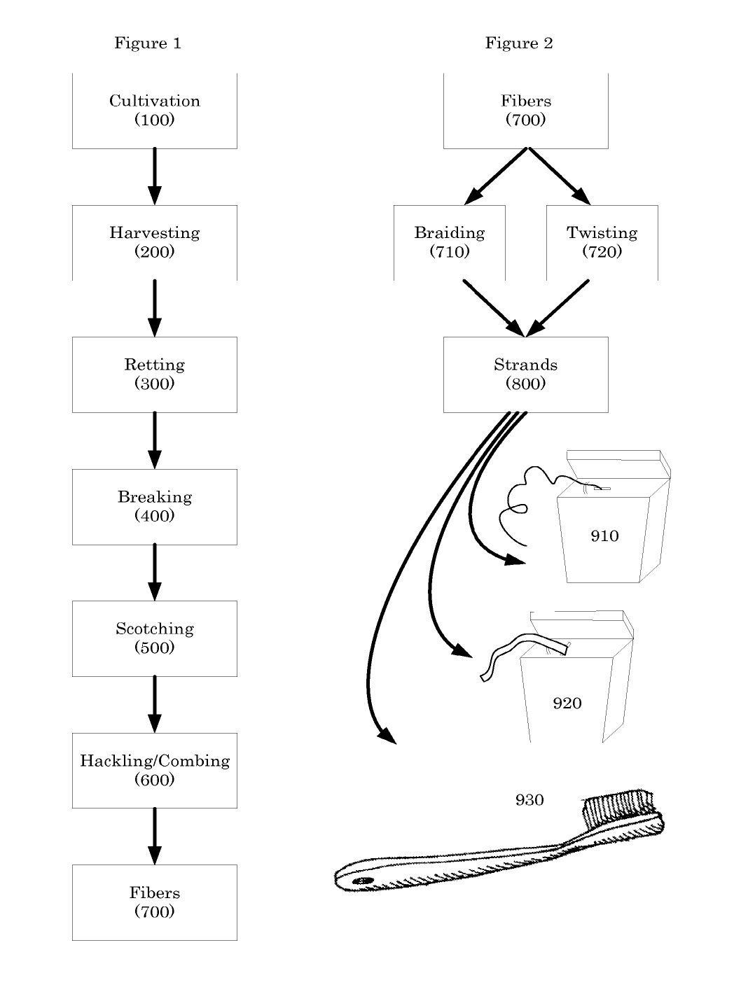

The leaf portions of this plant need to be processed as detailed in FIG. 1 such that individual fibers can be separated out and combined into strands. The plants are harvested 200, and are cut or pulled and then rotted somewhat to loosen the layers of material.

The fibers undergo retting 300 (in a pond, stream, or a field), breaking 400, scotching 500, and then hackling or combing 600, as required. The end result being a mass of long combed fibers.

The individual fibers are then combined into strands through either twisting 710 or braiding 720. The number of fibers combined to form a strand 800 can vary depending on the overall thickness desired, and the mechanical strength required. Multiple strands can also be combined to form thicker, stronger units, or can be manufactured such that they form a ribbon instead of a thread.

Once formed into strands, the strands can them be used directly in a dentrifice. As a floss 910, 920, the structure resulting from the strands is kept thin so that the floss may pass between teeth without undo force. As material for a tooth brush 930, multiple strands are grouped and used in a thicker structure to provide the stiffness necessary to clean the surface of teeth.

In addition to their inherent antimicrobial properties, the individual fibers can be combined with various additional antimicrobial agents, essential oils, and/or flavorings, as individual fibers, in bulk, or after further processing (as either strands or as semi-finished or finished products). Natural antimicrobial agents include organic acids, e.g. lactic acid, citric acid, acetic acid, and their salts. The essential oils used may comprise, but are not limited to: Cinnamon, Clove, Eucalyptus, Garlic, Kanuka, Leleshwa, Lavender, Lemon, Lemon myrtle, Manuka, Mint, Neem, Nigella sativa, Oregano, Onion, Peppermint, Sandalwood, Sideritis, Tea tree, Thyme. Flavorings may include Cinnamon, Lemon, Orange, Mint, Peppermint, Spearmint, etc.

### Benefits to Dental Hygene

There are over 600 types of bacteria found in the average mouth, some good, and some bad (causing or contributing to halitosis, gum disease, etc.). Several dozen of these can produce high levels of foul odors when incubated in the laboratory. The odors are produced mainly due to the anaerobic breakdown of proteins into individual amino acids, followed by the further breakdown of certain amino acids to produce detectable foul gases. For example, the breakdown of cysteine and methionine produce hydrogen sulfide and methyl mercaptan respectively. Volatile sulfur compounds have been shown to be statistically associated with oral malodor levels, and usually decrease following successful treatment.

With respect to the included example of Agave picta, A. picta has been shown to be useful in killing E. coli, L. monocytogenes, S. aureus, and V. cholerae, as well as acting as in inhibitor against yeast and molds.

A multi-strand thread floss comprising fibers A. picta along with other natural fibers will incorporate A. picta's inherent antimicrobial assets. As the cellular members of the fibers break, decompose, or rupture during use, they release enzymes which either directly kill various microbes (microbicidal), or prevent their growth (microbistatic). The effectiveness of the dental hygienic aid thus depends on the types and quantities of fibers chosen in each mixture. As is obvious even to a casual observer of this invention, the dental hygenic aids can be specifically manufactured to thwart a particular type or group of microbes, or to have a particular effect or effectiveness against certain microbes.

Other additives can likewise be included that increase the effectiveness of the dental hygenic aid in various capacities, such as: plaque inhibiting, antigingivitis, flouride solutions, oxygenated compounds (and/or peroxides), enamal strengtheners, etc.

1. A dental hygienic aid comprising a bundle of linear elements, wherein each of said elements comprises multiple strands of natural fiber, and wherein at least a portion of said natural fiber-based strands have inherent antimicrobial properties.

2. A device as in claim 1 wherein said strands are combined with at least one natural dentrifice.

3. A device as in claim 1 wherein said aid forms a ribbon floss.

4. A device as in claim 1 wherein said aid forms a thread floss.

5. A device as in claim 1 wherein said aid forms the bristles on a toothbrush.

6. A device as in claim 1 wherein said fiber is a bast fiber.

7. A device as in claim 1 wherein said fiber is a leaf fiber.

8. A device as in claim 1 wherein said fiber comprises a fiber selected from a group consisting of abacá, agave, flax, henequen, hemp, jute, kenaf, ramie, sisal, and yucca.

9. A device as in claim 1 wherein said fiber comprises a fiber selected from a group consisting of a member of the plant family Linaceae, Apocynaceae, Fabaceae, Tiliaceae, Malvaceae, Urticaceae, Musaceae, and Agavaceae.

10. A device as in claim 1 wherein said fiber has a denier of at least 100.

11. A device as in claim 1 wherein said fiber has a tensile strength of at least 30 cN/tex.

12. A method of manufacturing a dental hygienic aid comprising natural fibers having anti-microbial properties, comprising the steps of extracting a natural fiber into strands, assembling a series of strands to form a plurality of roving, and entangling said strands without the addition of binding agents, and without diminishing the anti-microbial properties present.

13. A method of claim 12 wherein said strands are twisted together.

14. A method of claim 12 wherein said strands are braided together.

15. A method of claim 12 wherein at least some strands have different thickness than other strands such that said aid has a non-uniform thickness.

16. (canceled)
